(19) United States
(12) Patent Application Publication
(10) Pub. No.: US 2025/0046939 A1
(43) Pub. Date: Feb. 6, 2025

(54) Electrical Energy Store, Motor Vehicle and Method for Producing an Energy Store

(71) Applicant: Bayerische Motoren Werke Aktiengesellschaft, Muenchen (DE)

(72) Inventors: Stephan MAIER, Dachau (DE); Werner SELIGER, Hallbergmoos (DE)

(21) Appl. No.: 18/718,269

(22) PCT Filed: Jan. 23, 2023
(86) PCT No.: PCT/EP2023/051480

§ 371 Date: Jun. 10, 2024

(30) Foreign Application Priority Data
Feb. 18, 2022 (DE) 10 2022 103 865.3

(51) Int. Cl. H01M 50/262; B60R 16/033; H01M 10/653; H01M 50/204; H01M 50/271; H01M 50/588

(52) U.S. Cl. CPC H01M 50/262; H01M 10/653; H01M 50/204; H01M 50/271; H01M 50/588; B60R 16/033; H01M 2220/20

(57) ABSTRACT

An electrical energy store, comprising a housing in which a unit made up of energy storage cells is located, at least some of the housing being fastened to the unit by means of an adhesive bond, and the adhesive bond being at least selectively weakened or releasable.

### BACKGROUND AND SUMMARY

The present invention relates to an electrical energy store, a motor vehicle, and a method for producing an energy store.

Electrical energy stores of the type under discussion are, for example, energy stores as are used in partially or fully electrically operated motor vehicles. Such energy stores have housings, which are often very large, in which the energy storage cells are housed. There are variants in this case in which the energy stores transmit structural forces. The cells arranged in the store housing are materially bonded to the housing in this case, for example, in particular adhesively bonded. Such an arrangement is known from EP 3 678 208 A1. In addition to some advantages which such concepts offer, the adhesive bonding of the cells to the housing makes subsequent analysis or the recycling of the energy stores at the end of life more difficult. This is due to the circumstance that the housing cannot be separated or can barely be separated from the energy storage cells adhesively bonded thereto. A store adhesively bonded once can thus no longer be readily opened. Recycling of the cells or exchanging defective cells or analysis in case of damage is thus not possible or is only possible with great effort.

It is therefore an object of the present invention to specify an electrical energy store, a motor vehicle, and a method for producing an energy store which are capable of eliminating the abovementioned disadvantages.

This object is achieved by an electrical energy store, a motor vehicle, and a method according to the present disclosure. Further advantages and features result from the description and the appended figures.

According to the invention, an electrical energy store comprises a housing, in which a group or an arrangement of energy storage cells is arranged, wherein the housing is fastened at least in some areas via an adhesive bond to the group and wherein the adhesive bond is designed to be weakened or detachable at least in some areas. The adhesive bond is advantageously constructed, produced, or designed so that it can be detached or destroyed/separated if needed, in particular later. This enables a nondestructive separation of the energy storage cells or the group from the surrounding housing. Exchanging energy storage cells identified as defective is thus possible without problems, for example. Moreover, the recycling of such an electrical energy store is significantly simplified, since disassembly into the components is possible in spite of the materially bonded adhesive bond.

According to one embodiment, the adhesive bond comprises a first adhesive layer and a second adhesive layer, wherein a separating layer is arranged between the first adhesive layer and the second adhesive layer, so that or by which the adhesive bond is weakened. Via the introduction, in particular embedding, of the separating layer in the adhesive bond, the latter can expediently be weakened in a targeted manner. In other words, a point or an area can thus be provided which enables the adhesive bond to be able to be detached again. The abovementioned separating layer can completely separate the first and the second adhesive layer in this case. Alternatively, the separating layer also has multiple recesses and/or holes, which enable the two adhesive layers to meet/touch. These areas then represent areas which are not weakened. This can be important for the design of the electrical energy store or the housing to achieve desired target variables. An adhesive bond, which is weakened entirely or at least in some areas, can thus advantageously be created very deliberately and as needed via the design of the separating layer.

According to one embodiment, the separating layer is designed such that the adhesive bond can be detached by peeling in the event of a load. According to one embodiment, the separating layer is positioned so that the adhesive bond can be detached upon opening of the housing. The opening of the housing represents, for example, a load case, which is different from a load case as occurs in normal use of the vehicle or also in an accident situation. In these two abovementioned cases, the adhesive bond should thus act as far as possible how a “normal” adhesive bond which is not designed as weakened or detachable would also act. A best possible orientation of the embedded separating layer is to be determined depending on the individual case of the geometry of the electrical store.

According to one embodiment, the first adhesive layer is applied to the housing, wherein the second adhesive layer is applied to the group. There are no restrictions for the adhesive layer with respect to the materials used. One-component and two-component adhesives, in particular structural adhesives, can be used. The first adhesive layer and the second adhesive layer can also be formed here from the same adhesive material. Alternatively, different adhesives/materials can be used.

According to one embodiment, the housing comprises a housing upper part and a housing lower part, wherein the housing upper part is detachably fastened via the adhesive bond on an upper side of the group. According to one preferred embodiment, the housing is a housing made of a metallic material such as a steel or also a light metal, such as aluminum. Material combinations, comprising plastics and/or composite materials, are also possible. The abovementioned housing upper part can thus also be produced from a material which is different from a material of the housing lower part. The fastening of the abovementioned housing upper part on the group takes place in a planar manner, in particular extensively, according to one embodiment, in order to enable a good load distribution. Accordingly, the abovementioned separating layer is also formed extensively and completely separates the first adhesive layer and the second adhesive layer. As already mentioned, however, it is also possible to provide the separating layer with holes and/or recesses. It is also possible to form the separating layer in the form of webs or strips arranged adjacent to one another, which are spaced apart from one another.

Metallic or also nonmetallic film-like materials can be used as the separating layer. Separating layers in the form of cloth-like or fabric-like materials can also be expedient.

According to one embodiment, the group of energy storage cells is embedded or potted using an adhesive or a potting compound. According to one embodiment, the abovementioned adhesive or the potting compound forms the second adhesive layer. According to one embodiment, the separating layer in the form of a film is applied directly to the cell potting. A second adhesive, the abovementioned first adhesive layer, for fastening the housing, for example, the housing upper part, is applied thereon in some areas or completely. Upon opening of the housing, the adhesive bond between the various adhesive layers can be separated along the weakest connection, in the present case in the area of the separating layer, for example, by peeling off the cover.

According to one embodiment, the adhesive bond has activatable components, in particular thermally activatable components, by which the material cohesion of the adhesive bond can be detached if needed. For example, energy/heat can be introduced via induction, which activates the abovementioned components. The activation is to be understood to mean that the material cohesion of the adhesive bond is dissolved. In particular, the cohesion within the adhesive bond is dissolved and this is thus weakened. A correspondingly fastened housing upper part can then also be removed without destruction. An adhesive bond designed as mentioned above, comprising activatable components, can be combined with the separating layer or with a separating layer.

According to one embodiment, the lower side of the group is fastened via the detachable adhesive bond or via a detachable adhesive bond to a housing lower part of the housing. The fastening can take place indirectly or directly. Indirectly means that according to one embodiment, the group is arranged on a support structure, which is in turn fastened on the housing lower part. The fastening of the support structure on the housing lower part and of the group on the support structure can be carried out via an adhesive bond which is weakened or detachable at least in some areas. Alternatively, the group can also be adhesively bonded directly on the housing lower part, preferably via a weekend or detachable adhesive bond.

The invention also relates to a motor vehicle, comprising at least one electrical energy store according to the invention. Motor vehicles of the type under discussion are, for example, motorcycles, passenger vehicles, or also utility vehicles, thus in particular land vehicles. In passenger vehicles, such electrical energy stores often occupy large areas of the underbody. The present embodiment enables a transfer of forces indirectly via the electrical energy store. This represents a fixed, stable unit due to the materially bonded connection of the group of the energy storage cells to the housing. However, as proposed, a possibility can be provided via the design of the adhesive bond of also reopening it or an energy store configured in this way.

The invention is also directed to a method for producing an electrical energy store, wherein a group of energy storage cells is fastened by material bonding on a housing of an energy store, and wherein an adhesive bond used for this purpose is designed as weakened or detachable. This advantageously enables deliberate separating of the adhesive bond, for example, to enable maintenance or service of the electrical energy store or to facilitate later recycling.

Various methods can be used to weaken the adhesive bond or to make it detachable.

According to one embodiment, the method comprises the following step:
weakening the adhesive bond by embedding a separating layer in the adhesive bond.

The separating layer represents a weakened layer which enables the adhesive bond to be detached. According to one embodiment, for example, a separating layer in the form of a film is applied to the group of energy storage cells. The abovementioned group is potted using a potting compound or using an adhesive according to one embodiment. The abovementioned film can advantageously be applied directly to the cell potting and adheres there. A housing upper part of the housing is fastened on the separating layer using a second adhesive, for example. Upon opening of the housing upper part, also called the cover, the adhesive bond between the adhesive layers, in the present case, for example, the cell potting, and the adhesive, which is introduced between the separating layer and the housing, can thus be separated along the film along the weakest connection, for example, by peeling off the cover.

Alternatively, one or more components can be introduced into the adhesive material which can be activated, for example, by introduction of energy. According to one embodiment, an adhesive bond designed in this way can be deliberately dissolved, for example, by introducing heat.

Further advantages and features result from the following description of an embodiment of an electrical energy store with reference to the appended figures.

### BRIEF DESCRIPTION OF THE DRAWINGS

FIG. 1: shows a schematic view of an embodiment of an electrical energy store in section;

FIG. 2: shows a detail view of an embodiment of an electrical energy store as outlined in FIG. 1.

### DETAILED DESCRIPTION OF THE DRAWINGS

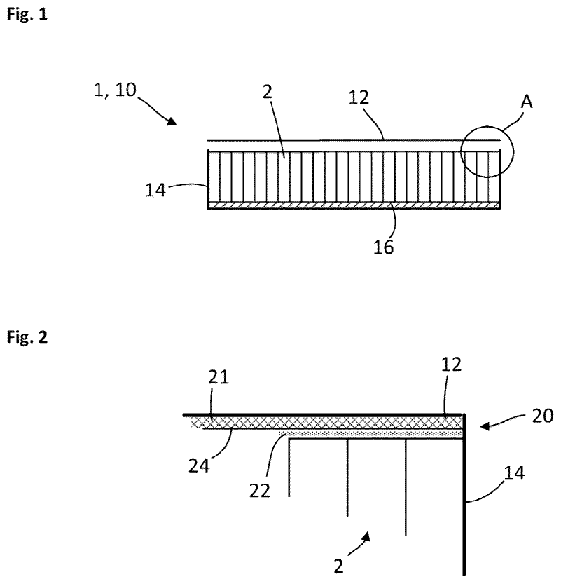

FIG. 1 shows a schematic representation of an energy store 1 comprising a housing 10, which has a housing upper part or a cover 12 and a housing lower part 14. The housing lower part 14 is designed as essentially trough-shaped in the present case. A large number of energy storage cells 2 are arranged in the housing lower part 14. The large number of energy storage cells 2 is also referred to in the present case as an arrangement or group. The arrangement of the energy storage cells 2 or the group is, for example, potted using a material. According to the present embodiment, the energy storage cells 2 are indirectly fastened via a support structure 16 on the housing lower part 14. The housing upper part 12 is positioned spaced apart in the present case. The housing upper part 12 is to be fastened via an adhesive bond, which is designed to be detachable and/or weakened, on the energy storage cells 2. The structure of such an adhesive bond will be explained in more detail on the basis of the detail A in FIG. 2.

FIG. 2 shows a detail view of the energy store known from FIG. 1, as outlined there with A. It can be seen that the housing upper part 12 is fastened via an adhesive bond 20 on the energy storage cells 2, which adhesive bond has a first adhesive layer 21 and a second adhesive layer 22. The abovementioned layers 21 and 22 are separated from one another via a separating layer 24. The separating layer 24 represents a type of predetermined breaking point of the adhesive bond 20. Upon opening of the cover or housing upper part 12, the adhesive bond 20 can be detached along the separating layer 24. The separating layer 24 is strained by peeling in this case, for example. The separating layer 24 is expediently oriented so that a load as occurs upon opening of the housing upper part 12 or the cover results in yielding of the separating layer 24 and detachment of the adhesive bond 20. According to one embodiment, the second adhesive layer 22 outlined in FIG. 2 can be the cell potting as such. An “extra” adhesive layer thus does not necessarily have to be applied. Instead, for example, a film-like separating layer 24 is laid on the cell potting, which is not yet cured, and the housing upper part 12 is then subsequently arranged above the first adhesive layer 21. Alternatively or additionally, the adhesive bond 20 can also at least partially comprise activatable components, wherein these are expediently designed such that upon an introduction of energy, for example, upon an introduction of heat, the adhesive bond 20 is caused to release. This can also enable opening of the housing upper part 12, as outlined in the present case.

### LIST OF REFERENCE SIGNS

1 energy store
2 energy storage cells
10 housing
12 housing upper part
14 housing lower part
16 support structure
20 adhesive bond
21 first adhesive layer
22 second adhesive layer
24 separating layer
A detail

1-11. (canceled)

12. An electrical energy store, comprising:
a housing, in which a group of energy storage cells are arranged,
wherein the housing is fastened to the group at least in some areas via an adhesive bond, and
wherein the adhesive bond is configured as weakened or detachable at least in some areas.

13. The electrical energy store according to claim 12,
wherein the adhesive bond comprises a first adhesive layer and a second adhesive layer, and
wherein a separating layer is arranged between the first adhesive layer and the second adhesive layer, by which the adhesive bond is weakened.

14. The electrical energy store according to claim 13,
wherein the separating layer is configured such that the adhesive bond can be detached by peeling in the event of a load.

15. The electrical energy store according to claim 12,
wherein the adhesive bond comprises a first adhesive layer and a second adhesive layer,
wherein the first adhesive layer abuts the housing, and
wherein the second adhesive layer abuts the group.

16. The electrical energy store according to claim 12,
wherein the housing comprises a housing upper part and a housing lower part, and
wherein the housing upper part is detachably fastened on an upper side of the group via the adhesive bond.

17. The electrical energy store according to claim 12,
wherein the adhesive bond comprises a first adhesive layer and a second adhesive layer,
wherein the group is embedded or potted using an adhesive or a potting compound, and
wherein the potting compound forms the second adhesive layer.

18. The electrical energy store according to claim 12,
wherein the adhesive bond comprises thermally activatable components, by which a material cohesion of the adhesive bond can be released.

19. The electrical energy store according to claim 12,
wherein a lower side of the group is fastened via the adhesive bond on a housing lower part of the housing.

20. A motor vehicle, comprising:
the electrical energy store according to claim 12.

21. A method for producing an energy store, the method comprising:
fastening a group of energy storage cells by material bonding to a housing of an energy store,
wherein an adhesive bond used for the fastening is configured as weakened or detachable at least in some areas.

22. The method according to claim 21, comprising:
weakening the adhesive bond by embedding a separating layer.

23. The method according to claim 22, comprising:
weakening the adhesive bond by embedding a separating layer between a first adhesive layer and a second adhesive layer of the adhesive bond.

24. The method according to claim 23, comprising:
abutting the first adhesive layer against the housing; and
abutting the second adhesive layer against the group.

25. The method according to claim 22, comprising:
detaching the adhesive bond by peeling the separating layer in in response to a load.

26. The method according to claim 21, comprising:
detachably fastened a housing upper part of the housing on an upper side of the group via the adhesive bond.

27. The method according to claim 21, comprising:
embedding or potting the group using an adhesive or a potting compound,
wherein the potting compound forms a second adhesive layer.

28. The method according to claim 21, comprising:
releasing a material cohesion of the adhesive bond via thermally activatable components of the adhesive bond.

29. The method according to claim 21, comprising:
fastening a lower side of the group via the adhesive bond on a housing lower part of the housing.
